(19) United States
(12) Patent Application Publication
(10) Pub. No.: US 2005/0283376 A1
(43) Pub. Date: Dec. 22, 2005

(54) Service level agreements supporting apparatus

(76) Inventors: Masanori Miyoshi, Mito (JP); Hiroshi Shojima, Hitachiota (JP); Hiroto Morizane, Hitachi (JP)

Correspondence Address: CROWELL & MORING LLP;INTELLECTUAL PROPERTY GROUP, P.O. BOX 14300, WASHINGTON, DC, 20044-4300, US

(21) Appl. No.: 10/930,983

(22) Filed: Aug. 30, 2004

(30) Foreign Application Priority Data
Jun. 18, 2004 (JP) JP2004-180400

(51) Int. Cl. G06F 17/60

(52) U.S. Cl. 705/1

(57) ABSTRACT

A service level agreements supporting apparatus that makes it possible to adjust the service level and select a service satisfying the customer, for maintenance service of buildings and facilities involving work specifications. The apparatus has a service level setting unit for setting a service level, a service specification determination unit for determining work specifications of a service corresponding to the set service level, a service quality prediction unit for predicting a service quality based on the determined work specifications, a service price prediction unit for predicting a service price based on the determined work specifications, and a service content exhibition unit for exhibiting these kinds of information.

### BACKGROUND OF THE INVENTION

The present invention relates to an apparatus for supporting service level agreements concluded between a management service provider of facilities, a building or the like and a customer.

As the enterprise management environment is aggravated, restructuring in enterprises is being promoted. In order to increase the competitive power in business, enterprises are concentrating resources to core business, which produces profits, and outsourcing indirect business called non-core business (entrusting service business to the outside of the enterprise).

As a contrivance for keeping the quality and service in a proper range when conducting the outsourcing, there is a SLA (Service Level Agreements). This is an agreement concerning the service quality concluded between a service recipient and a service provider. In the service level agreements, an evaluation index, which becomes the subject of the agreement, and its target value are indicated clearly. For example, if the number of days required for processing is selected as the evaluation index, the service level agreements become such that “The number of days required for processing should be three business days or less. It should be observed a hundred percent.”

The idea of service level agreements has spread in IT (Information Technology) services such as Internet connection service and call centers. As for a relating technique of the IT service, JP-A-2002-109401 entitled “service level control method and apparatus” can be mentioned. A technique for exhibiting a service levels and charges corresponding thereto to a customer is disclosed therein. By exhibiting the service levels and charges with the aid of this technique, it becomes possible for the customer to select a service having a high cost performance and it becomes possible to reach an agreement with the customer easily.

On the other hand, in connection with the facility management service, JP-A-2002-230196 entitled “elevator maintenance agreements support system” discloses a technique for exhibiting a failure occurrence probability and its charge that are expected when maintenance work is executed while following a maintenance plan, which determines an inspection frequency or the like, to a customer at the time of contract conclusion before the service start. By exhibiting the maintenance plan indicating the actual work contents, and effects and charges of services with this technique, the customer can determine whether the cost performance is good and it becomes possible to form agreements with the customer easily.

In the conventional technique disclosed in JP-A-2002-109401, only the service levels and charges are exhibited to the customer. Information concerning work specifications such as cleaning frequency and inspection frequency cannot be exhibited to the user. In the management service of a building or facilities, work specifications are created and charges are estimated on the basis of the work quantity in many cases. Therefore, the present conventional technique has a problem that it cannot be applied to the management service of a building or facilities as it is.

On the other hand, in the conventional technique disclosed in JP-A-2002-230196, it is possible to exhibit an index representing the service qualities, i.e., the charge and failure frequency, while centering around work specifications, i.e., the maintenance plan to the customer. In this conventional technique, however, it is not considered to adjust the service level and select a service satisfying the customer. Thus, this conventional technique has a problem that it cannot be applied to service level agreements as it is.

### SUMMARY OF THE INVENTION

The present invention has been achieved in order to solve the above-described problems. An object of the present invention is to provide a service level agreements supporting apparatus that makes it possible to adjust the service level and select a service satisfying the customer, for maintenance service of buildings and facilities involving work specifications.

A service level agreements supporting apparatus according to the present invention includes a service level setting unit for setting a service level, a service specification determination unit for determining work specifications of a service corresponding to the set service level, a service quality prediction unit for predicting a service quality on the basis of the determined work specifications, a service price prediction unit for predicting a service price on the basis of the determined work specifications, and a service content exhibition unit for exhibiting these kinds of information.

Other objects, features and advantages of the invention will become apparent from the following description of the embodiments of the invention taken in conjunction with the accompanying drawings.

### BRIEF DESCRIPTION OF THE DRAWINGS

FIG. 1 shows a functional configuration of a first embodiment of a service level agreements supporting apparatus according to the present invention;

FIG. 2 shows a processing flow in a service level agreements supporting apparatus shown in FIG. 1;

FIG. 3 shows details of service specification master data;

FIG. 4 shows an example of service specifications;

FIG. 5 shows an example of a service quality DB;

FIG. 6 shows an example of a service price DB;

FIG. 7 shows an example of an output view on a service contents exhibition unit;

FIG. 8 shows how a service level agreements supporting apparatus according to the present invention is used;

FIG. 9 shows message exchange conducted among a service level agreements supporting apparatus, a service provider, and a customer;

FIG. 10 shows a functional configuration of a second embodiment of a service level agreements supporting apparatus according to the present invention;

FIG. 11 shows a processing flow in a service level agreements supporting apparatus shown in FIG. 10;

FIG. 12 shows an example of a quality satisfaction degree conversion DB;

FIG. 13 shows an example of a price satisfaction degree conversion DB;

FIG. 14 shows an example of an output view on a service contents exhibition unit;

FIG. 15 shows a functional configuration of a third embodiment of a service level agreements supporting apparatus according to the present invention;

FIG. 16 shows a processing flow in a service level agreements supporting apparatus shown in FIG. 15;

FIG. 17 shows an outline of optimum service level estimation processing;

FIG. 18 shows details of optimum service level estimation processing;

FIG. 19 shows details of service level adjustment processing shown in FIG. 16;

FIGS. 20A and 20B show a method for calculating a quality satisfaction degree from a plurality of quality indexes;

FIG. 21 shows another example of an output view on a service contents exhibition unit;

FIG. 22 shows another example of an output view on a service contents exhibition unit; and

FIG. 23 shows a hardware configuration of a service level agreements supporting apparatus.

### DESCRIPTION OF THE EMBODIMENTS

### First Embodiment

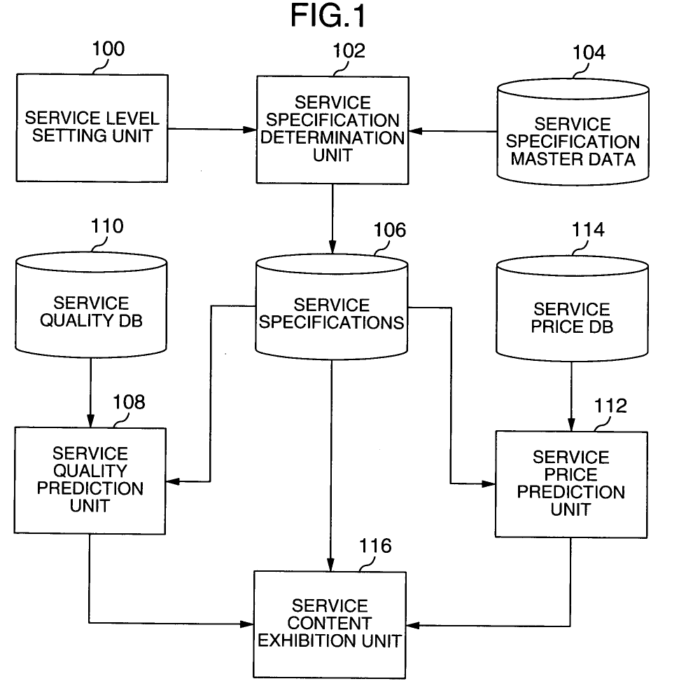

FIG. 1 shows a functional configuration of a first embodiment of a service level agreements supporting apparatus according to the present invention.

A service level setting unit 100 functions to specify a service level desired by the customer. The service level is a quantity that represents a height of a service level provided for a customer by a service provider. A service specification determination unit 102 determines service specifications 106 corresponding to a service level specified by the service level setting unit 100, on the basis of service specification master data 104. Here, the service specification master data 104 is a database that indicates a relation between the service level and service specifications. The service specifications 106 are specifications that prescribe a method for providing the customer with service. The service specifications 106 are represented by, for example, work specifications that determine a service providing frequency and its procedure. A service quality prediction unit 108 predicts a service quality obtained when the service provider provides service in accordance with the determined service-specifications 106, on the basis of a service quality DB (abbreviation of Data Base) 110. The service quality is obtained by quantifying the quality of provided service with an objective evaluation index. For example, in the case of cleaning service, the service quality is the number of claims for dirt. In the case of inspection service of facilities, the service quality is the failure probability of the facilities, the number of times of failure occurrence, the MTBF (Mean Time Between Failure), the MTTR (Mean Time To Repair), availability (ratio of time over which service can be actually provided to time over which the service should be provided), or the like. The service quality DB 110 is a database that indicates a relation between the service specifications 106 and the service quality. A service price prediction unit 112 predicts a price in the case where the service provider provides service in accordance with the determined service specifications 106, on the basis of a service price DB 114. The service price DB 114 is a database that indicates a relation between the service specifications 106 and the service price. A service content exhibition unit 116 displays the determined service specifications 106, a predicted value of the service quality predicted by the service quality prediction unit 108, and a predicted value of the service price predicted by the service price prediction unit 112 on a display device such as a display, in order to reach an agreement between the customer and the service provider as to service provided thereafter.

FIG. 23 shows a hardware configuration of the service agreements supporting apparatus shown in FIG. 1. In ensuing embodiments as well, their hardware configurations are similar to the configuration shown in FIG. 1.

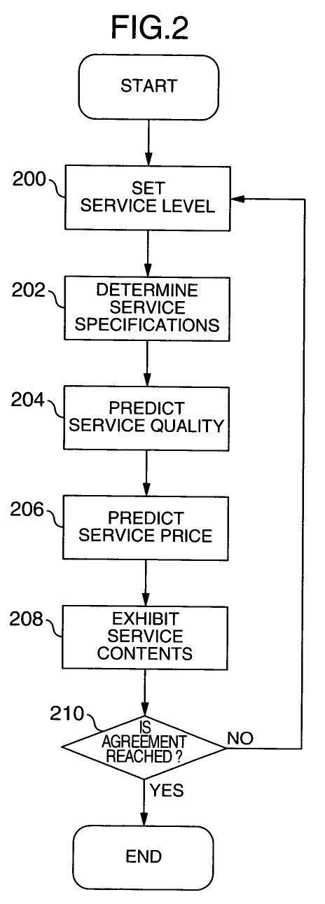

In FIG. 23, a CPU 10, i.e., an arithmetic processing apparatus conducts arithmetic processing in order to, for example, determine service specifications in accordance with the flow of processing described later (shown in, for example, FIG. 2). A program and fixed data for conducting arithmetic processing are stored in a ROM (Read Only Memory) 20. Data that are being subjected to processing execution are temporarily stored in a RAM (Random Access Memory) 30, and the RAM 30 is used as a work area for the CPU 10. A data input apparatus 40 is used for data input such as service level setting, and a pointing device such as a keyboard or a mouse is used. The service quality DB and the service price DB are stored in an auxiliary storage 50 such as a hard disk. These DBs may be stored in an external hardware storage, such as an external server. In this case, data are taken from the external DB via a communication interface 60. The service quality and the service price obtained by the CPU 10 by conducting the arithmetic processing are displayed on a display apparatus 70. The display apparatus 70 includes a display such as a liquid crystal panel. Printing may be conducted by a printer instead of the display.

FIG. 2 shows a flow of processing in the service level agreements supporting apparatus shown in FIG. 1. At step 200, a service level is set by using the service level setting unit 100. When first setting, a standard level may be set as an initial value, or a level for which an agreement has been reached by a dialogue with the customer may also be set. At step 202, service specifications corresponding to the service level set at the step 200 by using the service specification determination unit 102 are determined. At step 204, the service quality in the case where the service provider provides service in accordance with service specifications determined at the step 202 is predicted by using the service quality prediction unit 108. At step 206, the price in the case where the service provider provides service in accordance with service specifications determined at the step 202 is predicted by using the service price prediction unit 112. At step 208, the service specifications 106 determined at the step 202, the predicted value of the service quality predicted at the step 204, and the predicted value of the service price predicted at the step 206 are displayed on the display apparatus by using the service content exhibition unit 116. At step 210, it is determined whether an agreement is reached between the customer and the service provider as to service provided thereafter. If an agreement is not reached, then the processing returns to the step 200 to adjust the service level, and repeat the same processing again. If an agreement is reached, then the processing in the present system is finished and the procedure is advanced to conclusion of agreements concerning the service providing.

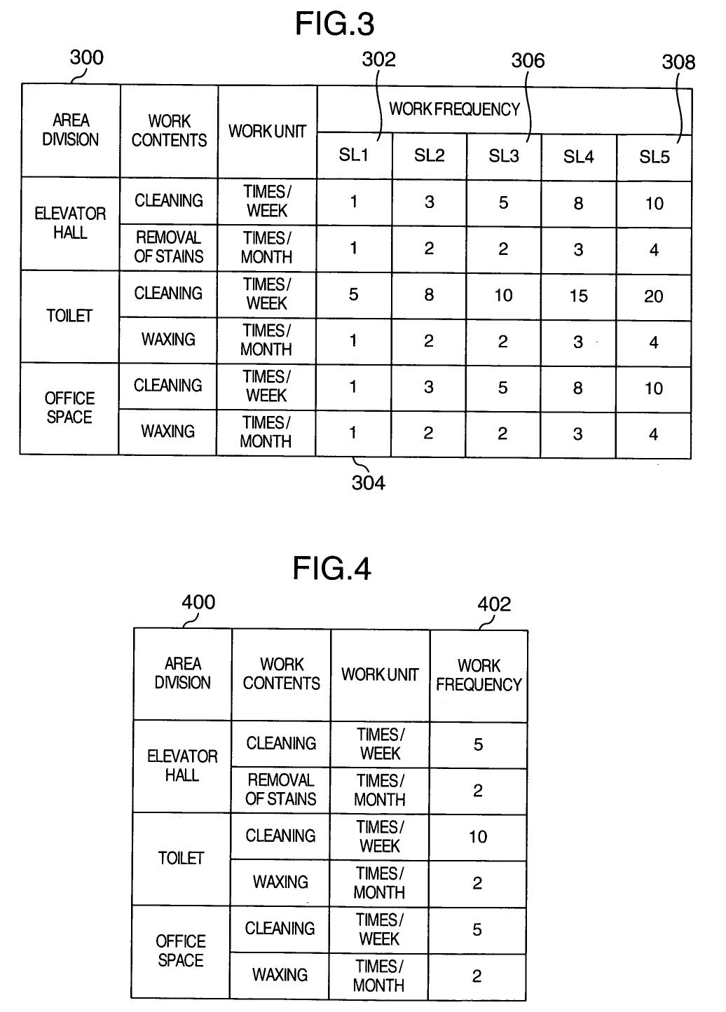

FIG. 3 shows details of service specification master data, which is a database showing the service level and service specifications. A table 300 is an example of the service specification master data 104 for cleaning service, and the work frequency with respect to work contents for each area division is stored every service level. Here, an example in which five service levels 1 to 5 are taken is shown. A cell 302 represents that a column of the cell 302 and subsequent columns indicate the work frequency for the lowest service level (service level 1). For example, it is found from a cell 304 that the work frequency for the service level 1 of waxing on an office space is once per month. In the same way, a cell 306 represents that a column of the cell 306 and subsequent columns indicate the work frequency for a standard service level (service level 3). A cell 308 represents that a column of the cell 308 and subsequent columns indicate the work frequency for the highest service level (service level 5). Although an example in which five service levels 1 to 5 are taken is shown, any number of levels may be adopted as occasion demands. If there are a large number of service levels, then it is possible to manually create only the work frequency for the lowest service level, the standard service level and the highest service level, and automatically create the work frequency for other service levels by using linear interpolation or the like.

FIG. 4 shows an example of service specifications determined by the service specification determination unit. A table 400 shows an example of the service specifications 106 determined when the table 300 shown in FIG. 3 is set as the service specification master data 104 and the service level 3 is specified by the service level setting unit 100. The service specification determination unit 102 selects the work frequency for the service level 3 in the table 300 and creates a column of the work frequency of a cell 402.

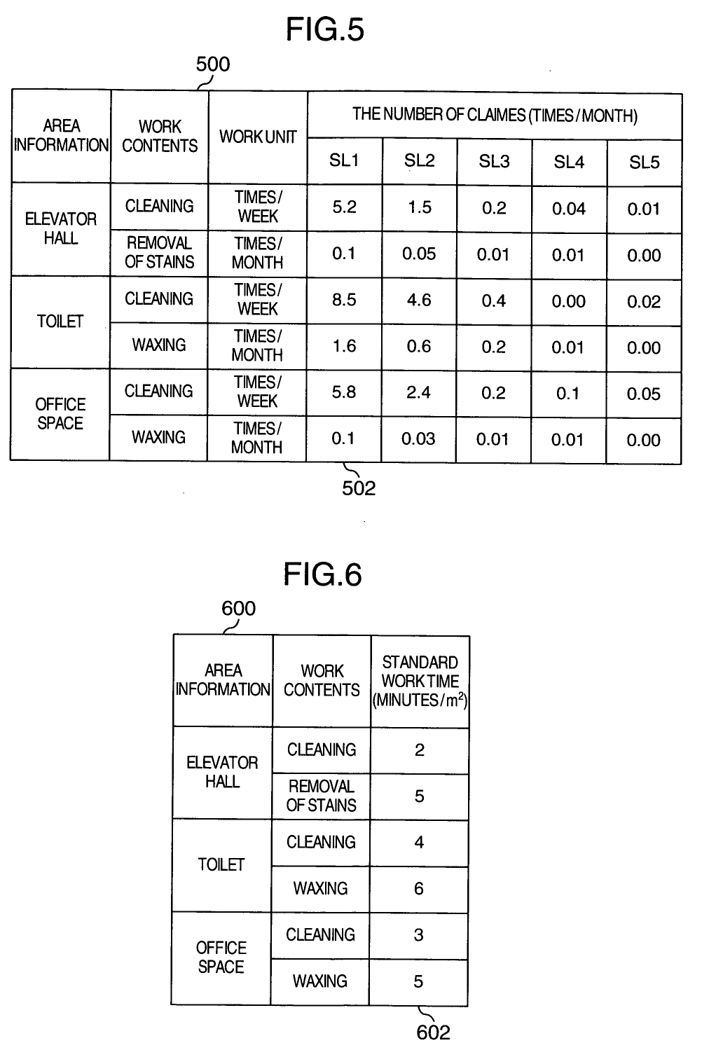

FIG. 5 shows an example of the service quality DB. A table 500 is the service quality DB 110 for the service specification master data 104 shown in FIG. 3, and past actual result values of the service quality for respective service items are stored for respective service levels. Here, an example in which the number of claims for the service is selected as an index representing the service quality is shown. For example, it is found from a cell 502 that the past actual result value of the number of claims for the service level 1 of the cleaning service on an office room is 0.1 times /month. This table can be created by recording the number of claims that have actually occurred when service is provided at work frequencies corresponding to respective service levels. By the way, as the index representing the service quality, one or more indexes such as the failure probability and the number of times of failure occurrence may be used besides the number of claims. In this case, past actual result values for respective indexes should be stored in the table 500.

FIG. 6 shows an example of the service price DB. A table 600 is a service price DB 114 corresponding to the service specification master data 104 shown in FIG. 3. Standard work time for work contents in each area division is stored in this table for each service level. For example, it is found from a cell 602 that the standard work time for the service level 1 of waxing on the office space is 5 minutes/m². This table can be created by recording actually taken work time when service is provided at a work frequency corresponding to each service level shown in Table 300. By the way, the service price can be calculated from the table 600 as hereafter described. Here, standard work time is a value obtained by referring to the table 600, and a work area is a value determined on the basis of information of a building of a work subject. A work unit price is a value determined from the labor cost of workers.
Price=Σ(standard work time×work area×work unit price) (expression 1)

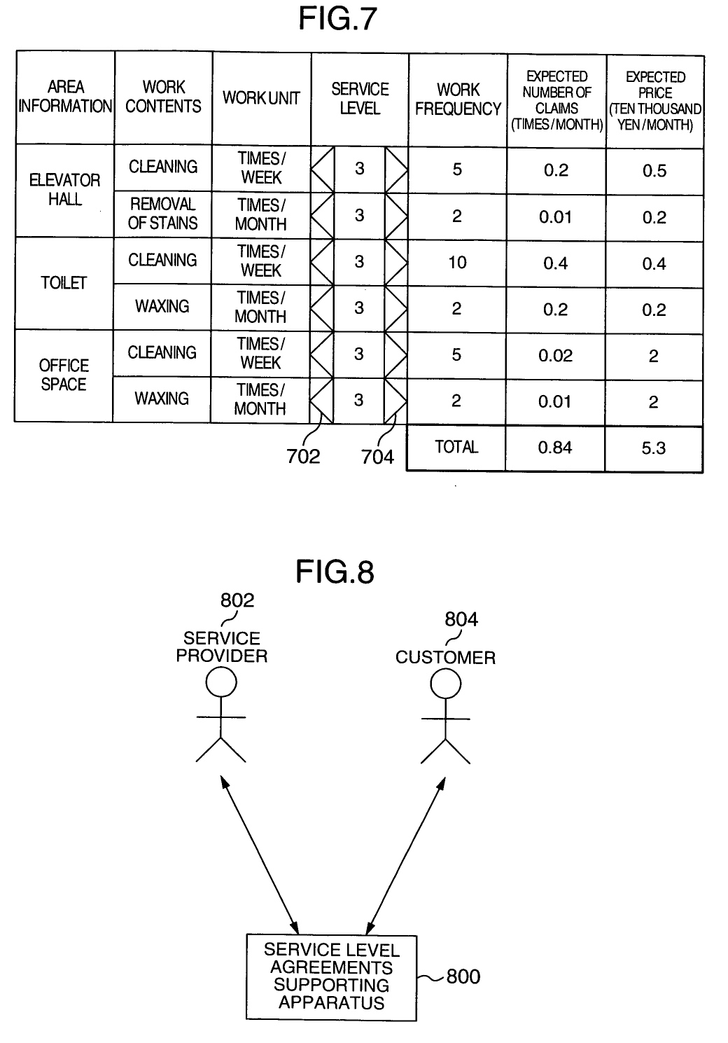

FIG. 7 shows an example of an output view of the service content exhibition unit. This synthetically shows the service specifications 106 determined by the service specification determination unit 102, the service quality predicted by the service quality prediction unit 108, and the service price predicted by the service price prediction unit 112. It is found from the bottom row of this table that the service level of waxing on the office space is 3, the work frequency is twice/month, the expected number of claims is 0.01 times/month, and the expected price is twenty thousand yen/month. Here, it is possible to lower the service and convey its result to the service level setting unit 100 by pressing a button 702, which is an interface for altering the service level. A button 704 is a button for raising the service level. As the service level is raised or lowered by using these buttons, the work frequency, the expected number of claims, and the expected price are updated. By changing the level while listening to intention of the customer who watches this view, therefore, it becomes possible to instantly grasp the predicted values of the service quality and price and support the arrival at an agreement.

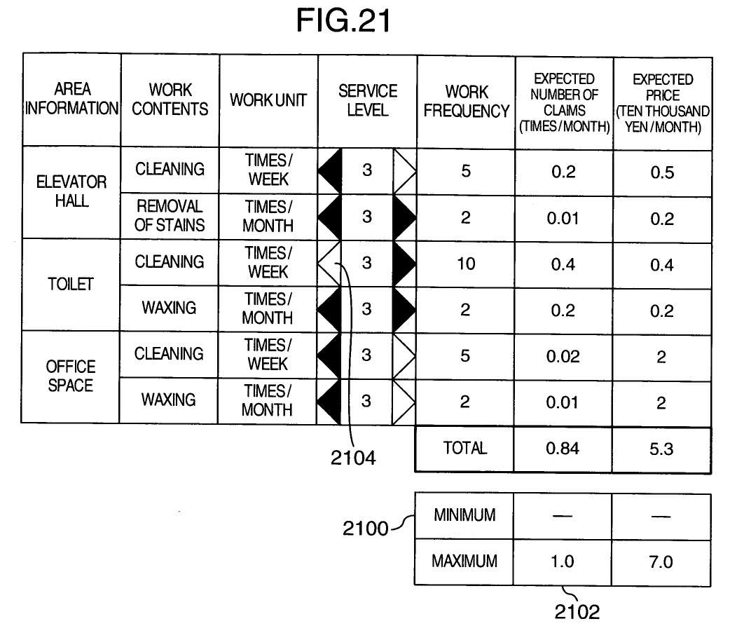

FIG. 21 shows another example of the output view of the service content exhibition unit. As represented by a table 2100, the view example shown in FIG. 7 is changed so as to allow the customer to set a maximum value and a minimum value for each of the expected number of claims and the expected price as an acceptable constraint condition. For example, a cell 2102 indicates that the maximum value of the expected number of claims acceptable to the customer is 1.0 time/month. If the service level is further lowered, the constraint condition is not satisfied. Therefore, a button 2104 is displayed as inactive and the level cannot be lowered. This can be implemented by previously checking whether the constraint condition is satisfied when the service level is raised or lowered by 1 for each service item and inactivating the corresponding button if the constraint condition is not satisfied.

FIG. 8 shows how the service level agreements supporting apparatus according to the present invention is used. The service level agreements supporting apparatus 800 is used by a service provider 802 and a customer 804.

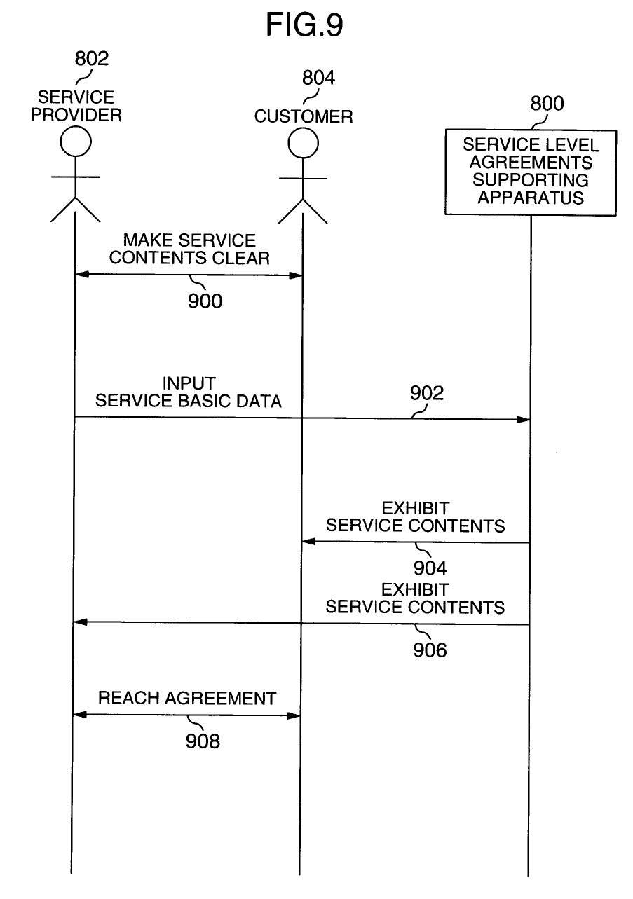

FIG. 9 shows exchange of messages among the service level agreements supporting apparatus, the service provider, and the customer. In a flow 900, the service provider 802 has a consultation with the customer 804 about service contents to be provided hereafter, and makes the service contents clear. In a flow 902, the service provider inputs service basic data made clear in the flow 900 to the service level agreements supporting apparatus 800. Specifically, items of service to be provided hereafter, the area of a subject region, the service level and so on are input to the service level agreements supporting apparatus 800. In a flow 904, the service level agreements supporting apparatus 800 prescribes the service contents on the basis of data input in the flow 902, and exhibits a result to the customer 804. At the same time, in a flow 906, the service level agreements supporting apparatus 800 exhibits the same information to the service provider 802 as well. Finally, in a flow 908, an agreement is reached between the service provider 802 and the customer 804 as to service to be provided hereafter, while the exhibited service contents is being confirmed. If an agreement is not reached as to the exhibited contents, then the processing returns to the flow 902 to adjust the service level and the processing ranging from the flow 902 to the flow 908 can be repeated again.

According to the present embodiment, it becomes possible to exhibit work specifications prescribing the service to be provided, the predicted value of the service quality and the predicted value of the service price to the customer. Even in the case of management service of a building or facilities involving work specifications, therefore, the service level agreements can be supported.

### Second Embodiment

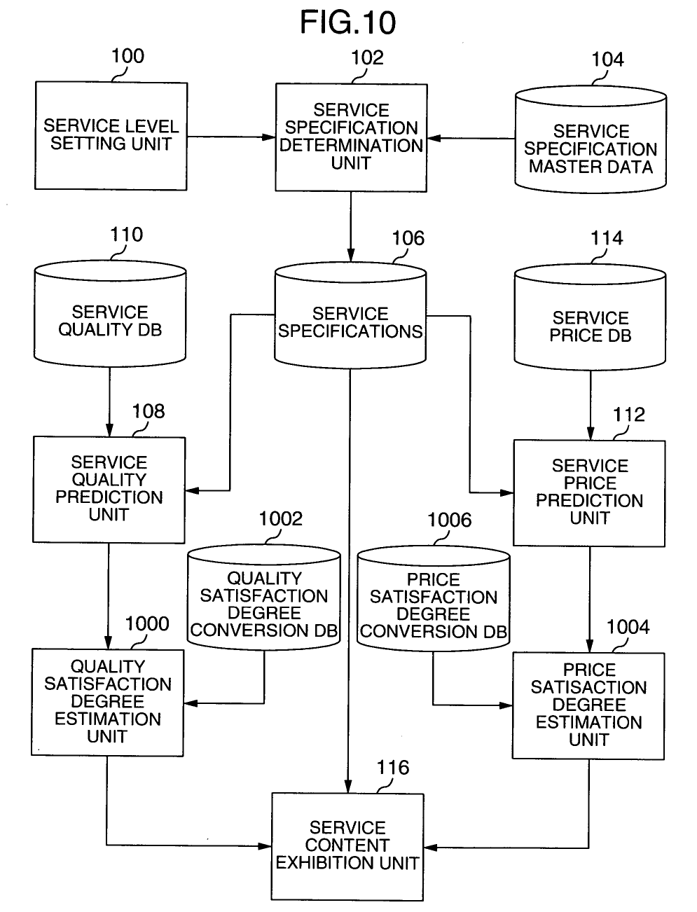

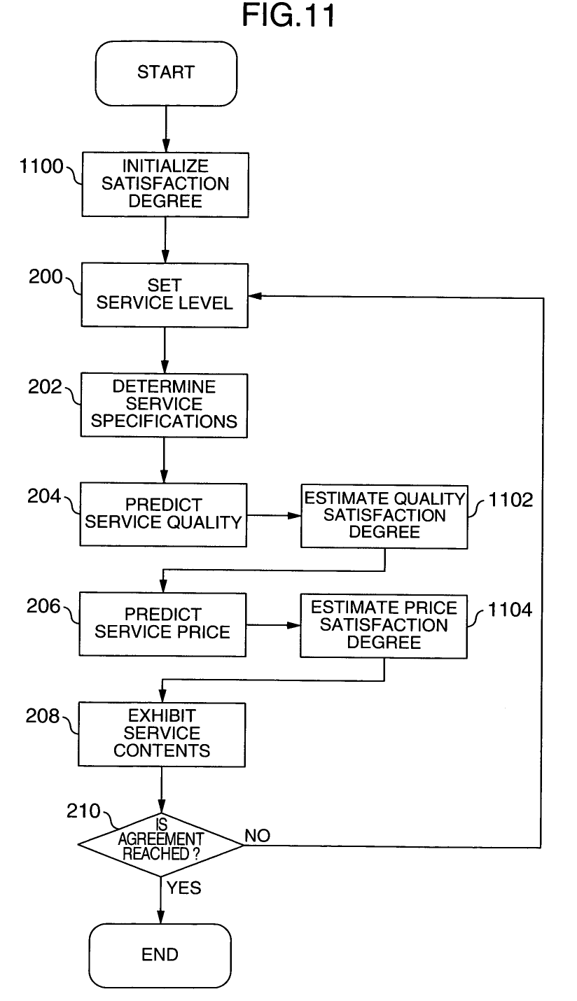

FIG. 10 shows a functional configuration of a second embodiment of a service level agreements supporting apparatus according to the present embodiment. In the first embodiment, the service specifications 106 determined by the service specification determination unit 102, the service quality predicted by the service quality prediction unit 108, and the service price predicted by the price prediction unit 112 are synthetically shown as shown in FIG. 7. In addition, in order to facilitate arrival at an agreement between the service provider and the customer, however, the degree of satisfaction of the customer at the the service quality and price may be estimated and exhibited by the service content exhibition unit 116 as shown in FIG. 10. In this case, a quality satisfaction degree estimation unit 1000 estimates the satisfaction degree of the customer at the service quality by using the service quality predicted by the service quality prediction unit 108 and using a quality satisfaction degree conversion DB 1002. In the same way, a price satisfaction degree estimation unit 1004 estimates the satisfaction degree of the customer at the service price by using the service price predicted by the service price prediction unit 112 and using a price satisfaction degree conversion DB 1006. And the service content exhibition unit 116 displays the degree of satisfaction of the customer at the service quality and the degree of satisfaction of the customer at the price. Other functions are the same as those described with reference to FIG. 1.

FIG. 11 shows a flow of processing conducted by the service level agreements supporting apparatus with due regard to the satisfaction degree shown in FIG. 10. Basically, this flow chart is the same as that shown in FIG. 2 in many steps, and steps 1100, 1102 and 1104 have been newly added. At the step 1100, the quality satisfaction degree conversion DB 1002 and the price satisfaction degree conversion DB 1006 are initialized while the intention of the customer is being taken in. At the step 1102, a degree of satisfaction of the customer at the service quality predicted at the step 204 is estimated by using the quality satisfaction degree estimation unit 1000. At the step 1104, a degree of satisfaction of the customer at the service price predicted at the step 206 is estimated by using the price satisfaction degree estimation unit 1004.

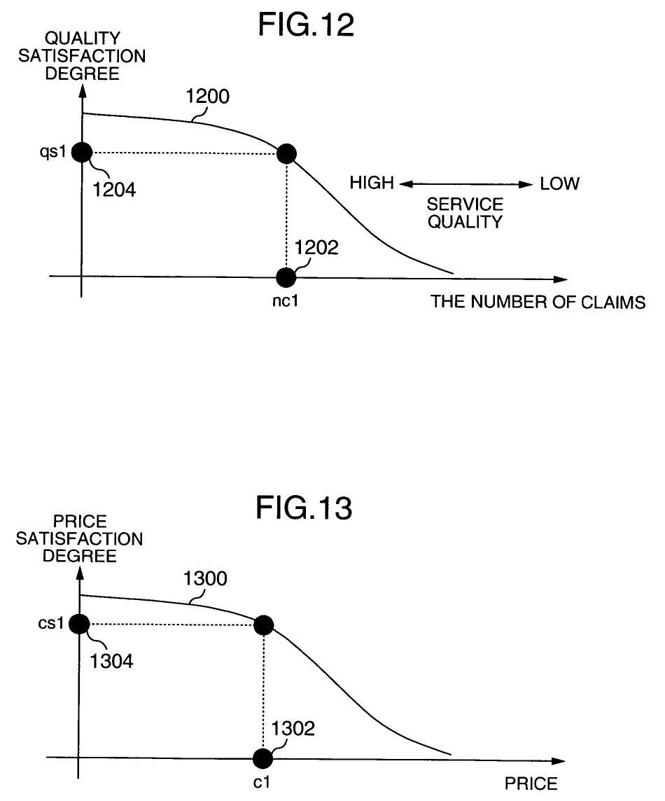

FIG. 12 shows an example of the quality satisfaction degree conversion DB. A curve 1200 shows a relation between the number of claims, which is one index of the service quality, and the satisfaction degree of the customer at the quality. The curve 1200 is stored in the quality satisfaction degree conversion DB 1002. A small number of claims mean that the service quality is high, and in this case the satisfaction degree of the customer becomes high. On the contrary, a large number of claims mean that the service quality is low, and in this case the satisfaction degree of the customer becomes low. By using this curve 1200, a quality satisfaction degree 1204 for a predicted number of claims 1202 can be obtained. This curve 1200 represents dependence of the customer satisfaction degree, which is a subjective quantity, upon the service quality. It is necessary to set the curve 1200 carefully while listening to the customers' intention. Furthermore, as occasion demands, it is also possible to prepare a graphical interface and make a customer set the curve 1200. In this way, the service level agreements supporting apparatus shown in FIG. 10 has a function of interactively editing the quality satisfaction degree conversion DB 1200.

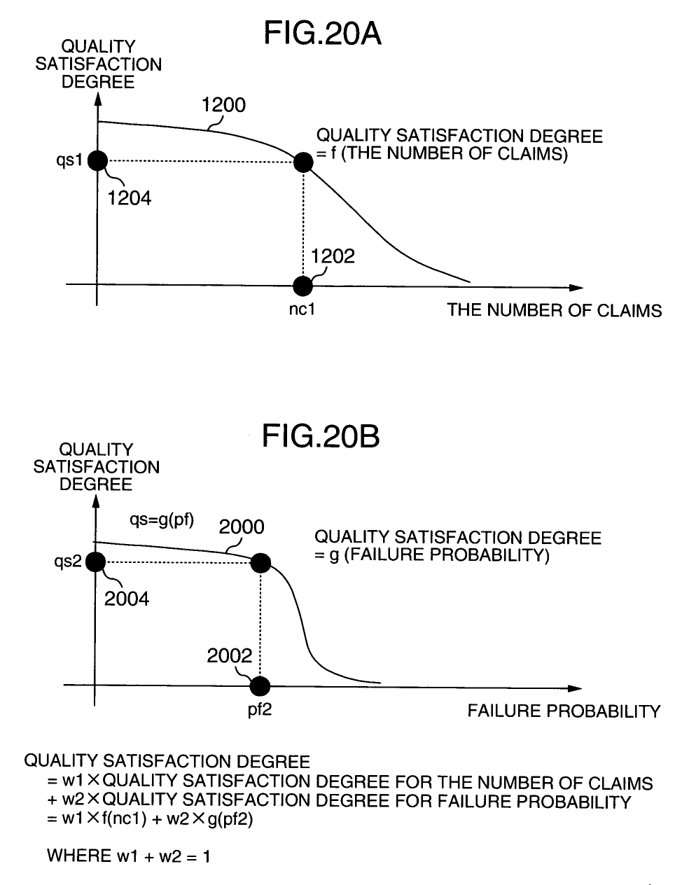

An example with one index, i.e., the number of claims selected as an index representing the service quality has been described with reference to FIG. 12. In the case where a plurality of indexes are selected as well, the quality satisfaction degree can be calculated in the same way. Its calculation method is shown in FIGS. 20A and 20B. A curve 1200 is the curve representing dependence of the quality satisfaction degree upon the number of claims described reference to FIG. 12. A curve 2000 is a curve representing dependence of the quality satisfaction degree upon the failure probability. If a certain service level is specified, a predicted value 1202 of the number of claims and a predicted value 2002 of the failure probability are predicted by the service quality prediction unit 108. A quality satisfaction degree 1204 is calculated for the predicted value 1202 of the number of claims. A quality satisfaction degree 1204 is calculated for the predicted value 1202 of the number of claims. In the same way, a quality satisfaction degree 2004 is calculated for a predicted value 2002 of the failure probability 2002. Finally, a value obtained by providing these predicted values with weights and adding up resultant products can be used as a quality satisfaction degree. In order to normalize the value, however, the sum total of the weights is set equal to unity.

FIG. 13 shows an example of a price satisfaction degree conversion DB. A curve 1300 represents dependence of the customer satisfaction degree upon the service price. In general, as the service price rises, the satisfaction degree of the customer tends to fall. By using the curve 1300, a price satisfaction degree 1304 for a predicted price 1302 can be obtained. This curve 1300 represents dependence of the customer satisfaction degree, which is a subjective quantity, upon the service price. It is necessary to set the curve 1300 carefully while listening to the customers' intention. As occasion demands, it is also possible to prepare a graphical interface and make a customer set the curve 1300. In this way, the service level agreements supporting apparatus shown in FIG. 10 has a function of interactively editing the price satisfaction degree conversion DB 1006.

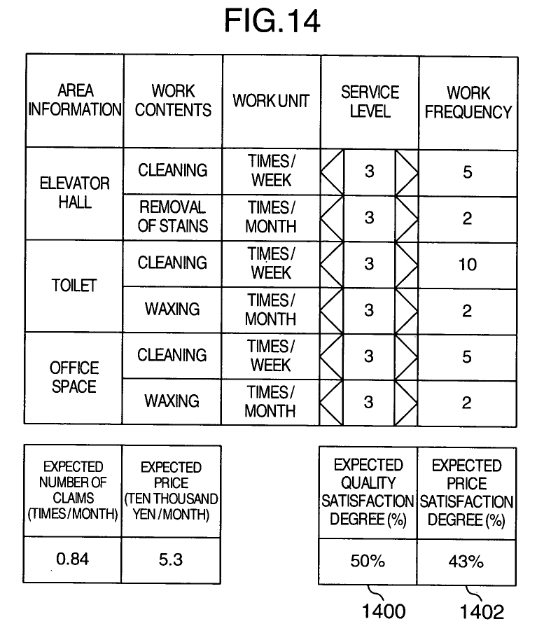

FIG. 14 shows an example of an output view of the service content exhibition unit. This is equivalent to the output view of the service content exhibition unit 116 shown in FIG. 7 with the quality satisfaction degree estimated by the quality satisfaction degree estimation unit 1000 and the price satisfaction degree estimated by the price satisfaction degree estimation unit 1004 added. In this view, the quality satisfaction degree is displayed in a cell 1400 and the price satisfaction degree is displayed in a cell 1402.

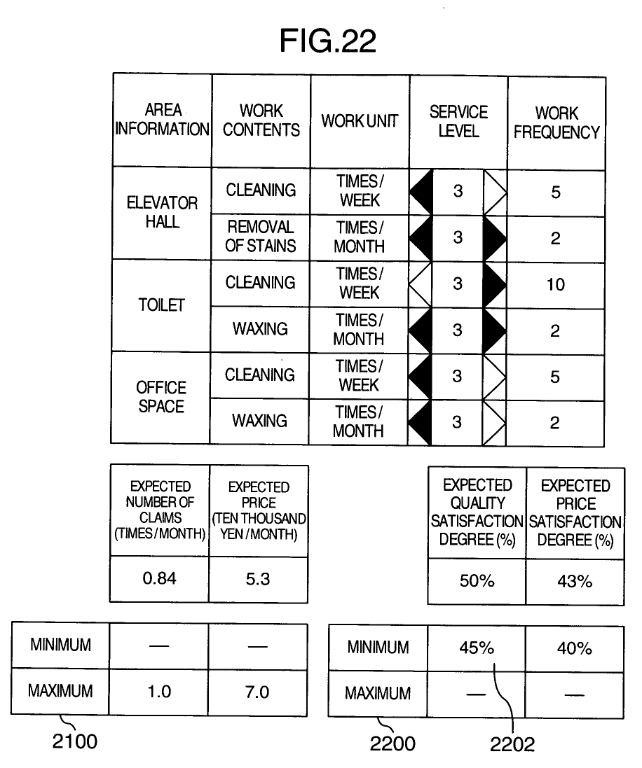

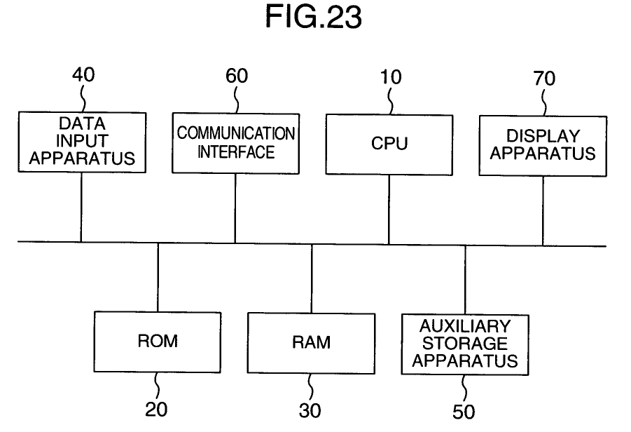

FIG. 22 shows another example of the output view of the service content exhibition unit. As represented by a table 2100 and a table 2200, the view example shown in FIG. 14 is changed so as to allow the customer to input an acceptable constraint condition. A maximum value and a minimum value can be set for each of the expected number of claims, the expected price, the expected quality satisfaction degree and the expected price satisfaction degree. For example, a cell 2202 indicates that the minimum value of the expected quality satisfaction degree acceptable to the customer is 45%. A button for adjusting the service level is displayed as inactive and its level is prevented from being altered in the same way as the case shown FIG. 21, if the constraint condition would not be satisfied when the service level were altered.

According to the present embodiment, a predicted value of the satisfaction degree in the quality aspect of the service and a predicted value of the satisfaction degree in the price aspect of the service can be known. Therefore, it becomes possible to quantitatively determine when concluding service level agreements whether the service is good.

### Third Embodiment

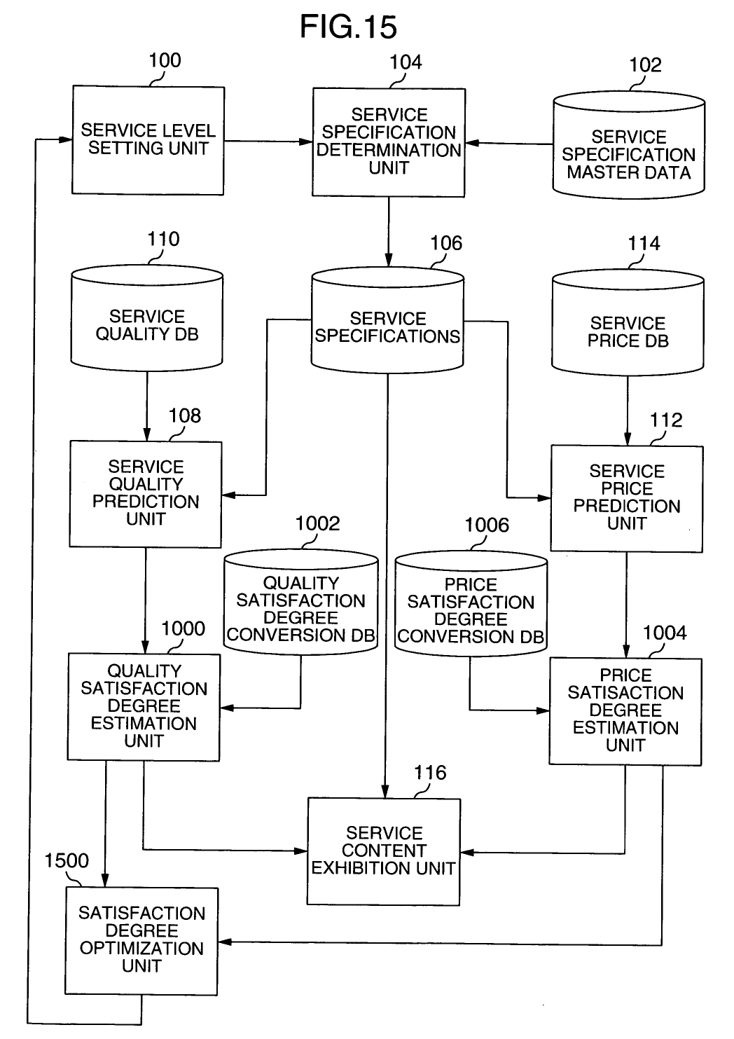

FIG. 15 shows a functional configuration of a third embodiment of a service level agreements supporting apparatus according to the present embodiment. In the second embodiment, the service specifications 106 determined by the service specification determination unit 102, the service quality predicted by the service quality prediction unit 108, the price predicted by the price prediction unit 112, the quality satisfaction degree estimated by the quality satisfaction degree estimation unit 1000, and the price satisfaction degree estimated by the price satisfaction degree estimation unit 1004 are synthetically shown as shown in FIG. 14. In addition, in order to save the labor, however, the service level may be automatically set so as to optimize the satisfaction degree. FIG. 15 shows a functional configuration of a service level agreements supporting apparatus including a satisfaction degree optimization unit. By using the quality satisfaction degree estimated by the quality satisfaction degree estimation unit 1000 and the price satisfaction degree estimated by the price satisfaction degree estimation unit 1004, a satisfaction degree optimization unit 1500 calculates a service level that maximizes the both satisfaction degrees, and sets a result in the service level setting unit 100. Other functions are the same as those described with reference to FIG. 10.

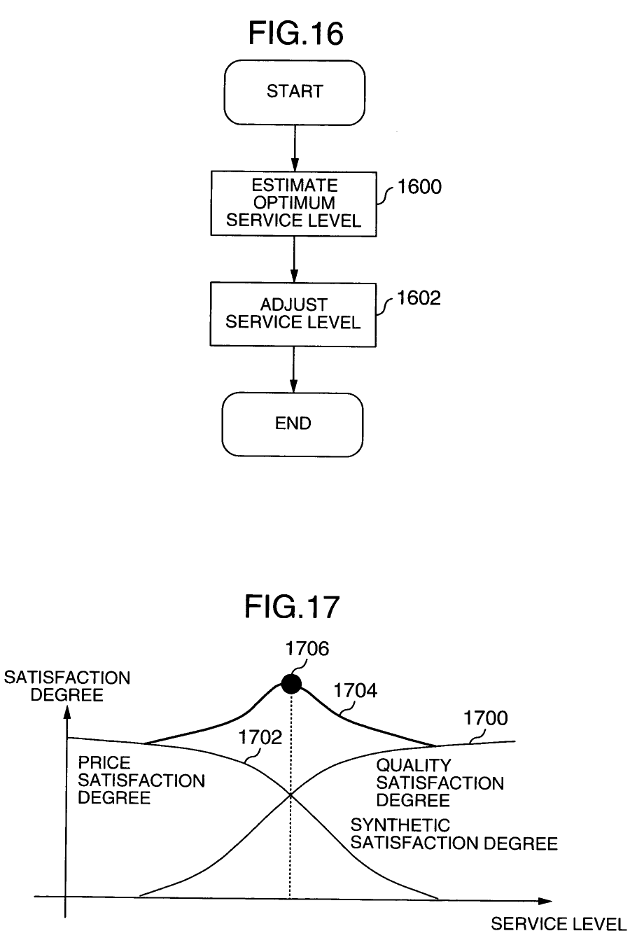

FIG. 16 shows a flow of processing conducted by the service level agreements supporting apparatus including the satisfaction degree optimization unit shown in FIG. 15. At step 1600, an optimum service level that maximizes the satisfaction degree of the customer is estimated. And at step 1602, a negotiation is conducted between the service provider and the customer, and an agreement is reached while the service level is being adjusted.

FIG. 17 shows an outline of optimum service level estimation processing. A curve 1700 shows a relation between the quality satisfaction degree estimated by the quality satisfaction degree estimation unit 1000 and the service level. A curve 1702 shows a relation between the price satisfaction degree estimated by the price satisfaction degree estimation unit 1004 and the service level. A curve 1704 is obtained by adding up the quality satisfaction degree (the curve 1700) and the price satisfaction degree (the curve 1702), and it is referred to as synthetic (or total) satisfaction degree herein. If one of the satisfaction degrees is 0, then that service level cannot be allowed and the synthetic satisfaction degree is also considered to be 0. In general, if the service level rises, then the quality satisfaction degree rises because the service quality becomes better, but on the other hand the price satisfaction degree falls because the service price rises. Conversely, if the service level falls, then the quality satisfaction degree falls because the service quality becomes worse, but on the other hand the price satisfaction degree rises because the service price falls. Therefore, the curve 1704 obtained by adding up them has a peak that maximizes the satisfaction degree as represented by a point 1706 shown in FIG. 17, and takes a shape so as to become lower in satisfaction degree as the service level rises or falls from the point 1706. Here, the service level corresponding to the point 1706 where the synthetic satisfaction degree is maximized becomes the estimation result at the step 1600.

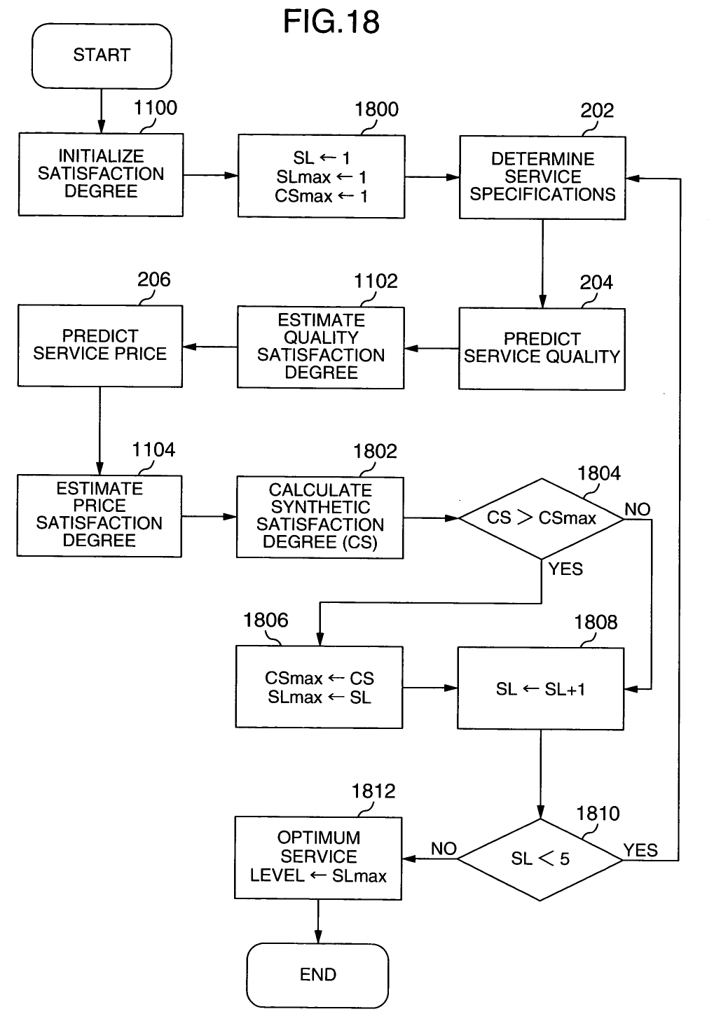

FIG. 18 shows details of the optimum service level estimation processing. The point 1706 where the synthetic satisfaction degree is maximized as shown in FIG. 17 is calculated, and a service level corresponding to that point is estimated. The step 1100 is the same as that shown in FIG. 11. At the step 1100, the quality satisfaction degree conversion DB 1002 and the price satisfaction degree conversion DB 1006 are initialized while customers' intention is being taken in. At step 1800, a variable for internal processing, i.e., the service level (SL), a maximum value of the customer satisfaction degree (CSmax), and the service level at that time (SLmax) are initialized. A following series of steps 202, 204, 1102, 206 and 1104 are provided to conduct the processing for estimating the quality satisfaction degree and the price satisfaction degree, and those steps are the same as those shown in FIG. 11. At step 1802, the quality satisfaction degree and estimated at the 1102 and the price satisfaction degree estimated at the step 1104 are added up to calculate the synthetic satisfaction degree (CS). At step 1804, comparison is conducted to determine whether the synthetic satisfaction degree (CS) calculated at the step 1802 is greater than the maximum value of the customer satisfaction degree (CSmax). If the synthetic satisfaction degree (CS) is greater, then the processing proceeds to step 1806. If the synthetic satisfaction degree (CS) is not greater, then the processing proceeds to step 1808. At the step 1806, the customer satisfaction degree of the service level (SL) now under processing is supposed to exhibit a maximum value, and the maximum value of the customer satisfaction degree (CSmax) and the service level (SLmax) at that time are updated. At step 1808, the service level (SL) is increased by 1 in order to make the next level of the service level (SL) now under processing a processing subject. At step 1810, comparison is conducted to determine whether the service level (SL) of the processing subject is within a subject range. Here, it is supposed that the service levels 1 to 5 are within the range as shown in FIG. 3, and comparison is conducted to determine whether the service level (SL) is less than 5. If the service level (SL) is less than 5 as a result of the comparison, then the processing proceeds to the step 202 and the processing proceeds to the processing for calculating the synthetic satisfaction degree for the next service level (SL). If the service level (SL) is at least 5, then the processing proceeds to step 1812. Finally, at the step 1812, a service level (SLmax) corresponding to the maximum value of the customer satisfaction degree (CSmax) is selected as an optimum service level.

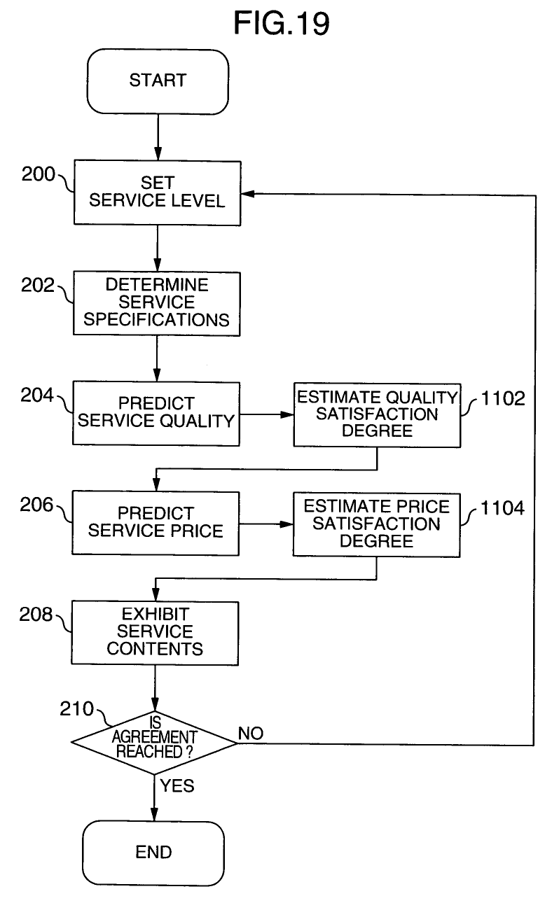

FIG. 19 shows details of the service level adjustment processing in FIG. 16. Basically, the flow is the same as the flow of processing conducted in the whole apparatus with due regard to the satisfaction degree shown in FIG. 11 except that the processing of initializing the satisfaction degree at the step 1100 shown in FIG. 11 is not included. The reason is that the same processing has already been executed at the step 1100 shown in FIG. 18 and wasteful processing should be avoided.

According to the present embodiment, the service level that maximizes the satisfaction degree for both the service and price can be calculated. Therefore, an optimum service level desired by the customer can be automatically determined.

According to the present invention, it is possible to exhibit work specifications that prescribe service to be provided, the predicted value of the service quality, and the predicted value of the service price to a customer. In addition, it is also possible to adjust the service level. Even in the management service of a building or facilities, therefore, it becomes possible to support service level agreements.

It should be further understood by those skilled in the art that although the foregoing description has been made on embodiments of the invention, the invention is not limited thereto and various changes and modifications may be made without departing from the spirit of the invention and the scope of the appended claims.

1. A service level agreements supporting apparatus comprising:
service level setting means for setting a service level to a service to be provided;
service specification determination means for determining work specifications of a service corresponding to the service level;
service quality prediction means for predicting a service quality on the basis of the work specifications;
service price prediction means for predicting a service price on the basis of the work specifications; and
service content exhibition means for exhibiting the work specifications, a predicted value of the service quality, and a predicted value of the service price.

2. The service level agreements supporting apparatus according to claim 1, wherein said service quality prediction means adopts one index or a plurality of indexes selected from among the number of claims, failure probability, the number of times of failure occurrence, MTBF (Mean Time Between Failure), MTTR (Mean Time To Repair) and availability, as the service quality.

3. The service level agreements supporting apparatus according to claim 1, wherein said service content exhibition means exhibits an interface for altering the service level.

4. The service level agreements supporting apparatus according to claim 1, wherein said service content exhibition means can set a maximum value and a minimum value for each of the service quality and the service price as a constraint condition, and inactivates an interface for altering the service level when the constraint condition cannot be satisfied.

5. The service level agreements supporting apparatus according to claim 1, further comprising:
quality satisfaction degree estimation means for estimating a satisfaction degree of a customer at the service quality; and
price satisfaction degree estimation means for estimating a satisfaction degree of the customer at the service price.

6. The service level agreements supporting apparatus according to claim 5, wherein said quality satisfaction degree estimation means calculates quality satisfaction degrees respectively for the indexes adopted as the service quality, adding up weighted quality satisfaction degrees, and uses a resultant value as a satisfaction degree of the customer for the service quality.

7. The service level agreements supporting apparatus according to claim 5, wherein said quality satisfaction degree estimation means has a function of interactively editing a quality satisfaction degree conversion database to be referred to when estimating a satisfaction degree, and a function of interactively editing a price satisfaction degree conversion database to be referred to when estimating the satisfaction degree.

8. The service level agreements supporting apparatus according to claim 5, wherein said service content exhibition means displays the satisfaction degree of the customer at the service quality and the satisfaction degree of the customer at the service price.

9. The service level agreements supporting apparatus according to claim 8, wherein said service content exhibition means can set a maximum value and a minimum value for each of the satisfaction degree of the customer at the service quality and the satisfaction degree of the customer at the service price as a constraint condition, and inactivates an interface for altering the service level when the constraint condition cannot be satisfied.

10. The service level agreements supporting apparatus according to claim 5, further comprising satisfaction degree optimization means for optimizing the satisfaction degree of the customer at the service quality and the satisfaction degree of the customer at the service price.

11. The service level agreements supporting apparatus according to claim 10, wherein said satisfaction degree optimization means calculates a service level that maximizes a total value of the satisfaction degree of the customer at the service quality and the satisfaction degree of the customer at the service price, and sets the service level in said service level setting means.

12. The service level agreements supporting apparatus according to claim 2, further comprising:
quality satisfaction degree estimation means for estimating a satisfaction degree of a customer at the service quality; and
price satisfaction degree estimation means for estimating a satisfaction degree of the customer at the service price.

13. The service level agreements supporting apparatus according to claim 12, wherein said quality satisfaction degree estimation means calculates quality satisfaction degrees respectively for the indexes adopted as the service quality, adding up weighted quality satisfaction degrees, and uses a resultant value as a satisfaction degree of the customer for the service quality.

14. The service level agreements supporting apparatus according to claim 12, wherein said quality satisfaction degree estimation means has a function of interactively editing a quality satisfaction degree conversion database to be referred to when estimating a satisfaction degree, and a function of interactively editing a price satisfaction degree conversion database to be referred to when estimating the satisfaction degree.

15. The service level agreements supporting apparatus according to claim 12, wherein said service content exhibition means displays the satisfaction degree of the customer at the service quality and the satisfaction degree of the customer at the service price.

16. The service level agreements supporting apparatus according to claim 15, wherein said service content exhibition means can set a maximum value and a minimum value for each of the satisfaction degree of the customer at the service quality and the satisfaction degree of the customer at the service price as a constraint condition, and inactivates an interface for altering the service level when the constraint condition cannot be satisfied.

17. The service level agreements supporting apparatus according to claim 12, further comprising satisfaction degree optimization means for optimizing the satisfaction degree of the customer at the service quality and the satisfaction degree of the customer at the service price.

18. The service level agreements supporting apparatus according to claim 17, wherein said satisfaction degree optimization means calculates a service level that maximizes a total value of the satisfaction degree of the customer at the service quality and the satisfaction degree of the customer at the service price, and sets the service level in said service level setting means.

19. The service level agreements supporting apparatus according to claim 3, further comprising:
quality satisfaction degree estimation means for estimating a satisfaction degree of a customer at the service quality; and
price satisfaction degree estimation means for estimating a satisfaction degree of the customer at the service price.

20. The service level agreements supporting apparatus according to claim 19, wherein said quality satisfaction degree estimation means calculates quality satisfaction degrees respectively for the indexes adopted as the service quality, adding up weighted quality satisfaction degrees, and uses a resultant value as a satisfaction degree of the customer for the service quality.

21. The service level agreements supporting apparatus according to claim 19, wherein said quality satisfaction degree estimation means has a function of interactively editing a quality satisfaction degree conversion database to be referred to when estimating a satisfaction degree, and a function of interactively editing a price satisfaction degree conversion database to be referred to when estimating the satisfaction degree.

22. The service level agreements supporting apparatus according to claim 19, wherein said service content exhibition means displays the satisfaction degree of the customer at the service quality and the satisfaction degree of the customer at the service price.

23. The service level agreements supporting apparatus according to claim 22, wherein said service content exhibition means can set a maximum value and a minimum value for each of the satisfaction degree of the customer at the service quality and the satisfaction degree of the customer at the service price as a constraint condition, and inactivates an interface for altering the service level when the constraint condition cannot be satisfied.

24. The service level agreements supporting apparatus according to claim 19, further comprising satisfaction degree optimization means for optimizing the satisfaction degree of the customer at the service quality and the satisfaction degree of the customer at the service price.

25. The service level agreements supporting apparatus according to claim 24, wherein said satisfaction degree optimization means calculates a service level that maximizes a total value of the satisfaction degree of the customer at the service quality and the satisfaction degree of the customer at the service price, and sets the service level in said service level setting means.

26. The service level agreements supporting apparatus according to claim 4, further comprising:
quality satisfaction degree estimation means for estimating a satisfaction degree of a customer at the service quality; and
price satisfaction degree estimation means for estimating a satisfaction degree of the customer at the service price.

27. The service level agreements supporting apparatus according to claim 26, wherein said quality satisfaction degree estimation means calculates quality satisfaction degrees respectively for the indexes adopted as the service quality, adding up weighted quality satisfaction degrees, and uses a resultant value as a satisfaction degree of the customer for the service quality.

28. The service level agreements supporting apparatus according to claim 26, wherein said quality satisfaction degree estimation means has a function of interactively editing a quality satisfaction degree conversion database to be referred to when estimating a satisfaction degree, and a function of interactively editing a price satisfaction degree conversion database to be referred to when estimating the satisfaction degree.

29. The service level agreements supporting apparatus according to claim 26, wherein said service content exhibition means displays the satisfaction degree of the customer at the service quality and the satisfaction degree of the customer at the service price.

30. The service level agreements supporting apparatus according to claim 29, wherein said service content exhibition means can set a maximum value and a minimum value for each of the satisfaction degree of the customer at the service quality and the satisfaction degree of the customer at the service price as a constraint condition, and inactivates an interface for altering the service level when the constraint condition cannot be satisfied.

31. The service level agreements supporting apparatus according to claim 26, further comprising satisfaction degree optimization means for optimizing the satisfaction degree of the customer at the service quality and the satisfaction degree of the customer at the service price.

32. The service level agreements supporting apparatus according to claim 31, wherein said satisfaction degree optimization means calculates a service level that maximizes a total value of the satisfaction degree of the customer at the service quality and the satisfaction degree of the customer at the service price, and sets the service level in said service level setting means.
